(19) United States
(12) Patent Application Publication
(10) Pub. No.: US 2025/0357702 A1
(43) Pub. Date: Nov. 20, 2025

(54) ELECTRONIC CONNECTOR ASSEMBLY AND FEMALE CONNECTOR THEREOF

(71) Applicant: ACES ELECTRONICS CO., LTD., Taoyuan City (TW)

(72) Inventors: Rong-Hsun KUO, Taoyuan City (TW); Kuei-Ta HSIEH, Taoyuan City (TW)

(21) Appl. No.: 18/763,165

(22) Filed: Jul. 3, 2024

(30) Foreign Application Priority Data
May 20, 2024 (TW) 113118666

(51) Int. Cl. H01R 13/627; H01R 13/502

(52) U.S. Cl. CPC H01R 13/6275; H01R 13/502

(57) ABSTRACT

An electronic connector assembly has a female connector and a male connector. The female connector has terminal base mounted in a housing and having an insulation base and multiple metal terminals. The insulation base has a base and a tongue. A hard wall is embedded in two opposite sides and a front side of the tongue. Each sidewall has a notch defined in at least one position corresponding to a top surface or a bottom surface of the tongue and exposed from the tongue to engage a locking element in the male connector.

### CROSS-REFERENCE TO RELATED APPLICATIONS

This application is based upon and claims priority under 35 U.S.C. 119 from Taiwan Patent Application No. 113118666 filed on May 20, 2024, which is hereby specifically incorporated herein by this reference thereto.

### BACKGROUND OF THE INVENTION

### 1. Field of the Invention

The present invention relates to an electronic connector assembly.

### 2. Description of the Prior Arts

A female connector is usually mounted on an electrical product or a computer to fit with a male connector for transferring information or charging. The conventional female connector has a tongue on which multiple metal terminals are mounted and inserted into a socket formed in the male connector. Such that, the metal terminals contact multiple metal terminals mounted on the inner wall of the socket of the male connector.

However, the sizes of the conventional connectors are different based on different transfer standards, so the tongue of the conventional female connector may be damaged by a metal casing of an inclinedly inserting male connector or the metal casing of a smaller male connector. Therefore, a metal middle board is usually embedded in the tongue to improve its structural strength of the tongue. However, the metal middle board has a thickness, so the thickness of the tongue is increased. Therefore, the application of the conventional female connector is limited, and the conventional female connector is needed to be improved.

To overcome the shortcomings, the present invention provides an electronic connector assembly and a female connector thereof to mitigate or to obviate the aforementioned problems.

### SUMMARY

In according to the application limitation of the conventional female connector having a tongue with a metal middle board, the objective of the present invention is to provide an electronic connector assembly and a female connector thereof to improve the structural strength of the tongue without a metal middle board, to keep the thickness of the tongue from being increased, and to improve the connection with a male connector by locking elements.

To achieve the aforementioned objective, the present invention provides an electronic connection comprising
a female connector comprising
   a first housing;
   a terminal base mounted in the first housing and comprising an insulation base and at least one terminal assembly mounted on a tongue formed on the insulation base; and
   a hard wall embedded in two opposite sides and a front side of the tongue, being harder than the tongue, and comprising
      two sidewalls partially embedded respectively in the two opposite sides of the tongue, and each sidewall having a notch defined in at least one position corresponding to a top surface or a bottom surface of the tongue and exposed from the tongue; and
      a front wall embedded in the front side of the tongue and located between the two sidewalls of the hard wall; and
a male connector selectively inserted into the female connector and comprising
   a casing;
   a resilient terminal mount mounted in the casing and comprising an insulation socket and at least one resilient terminal assembly mounted in the insulation socket, wherein when the male connector is inserted into the female connector, the at least one resilient terminal assembly is in contact the at least one metal terminal assembly of the female connector; and
   a locking element mounted in the insulation socket, being adjacent to one of two inner sidewalls of the insulation socket, wherein when the male connector is inserted into the female connector, the locking element is engaged with the notch defined in a corresponding one of the sidewalls of the hard wall.

With the aforementioned features, the female connector of the electronic connector assembly in accordance with the present invention has the hard wall embedded in the two opposite sides and the front side of the tongue. Each sidewall has a notch defined in at least one position corresponding to a top surface or a bottom surface of the tongue and exposed from the tongue and exposed from the tongue. When a male connector is inserted into the female connector, the locking element is engaged with the notches in the sidewall of the hard wall. Accordingly, the structural strength of the tongue of the female connector of the electronic connector assembly in accordance with the present invention can be improved, and the connection between the male connector and female connector can also be improved to keep the male connector from being detached from the female connector.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a terminal base of a female connector in accordance with the present invention;

FIG. 2 is an exploded perspective view of the female connector in accordance with the present invention;

FIG. 3 is a cross sectional front view of the female connector in FIG. 2;

FIG. 4 is a cross sectional perspective view of the female connector in FIG. 2;

FIG. 5 is a cross sectional side view of an electronic connector assembly in accordance with the present invention;

FIG. 6 is a front view of another embodiment of a female connector in accordance with the present invention;

FIG. 7 is a front view of a further embodiment of a female connector in accordance with the present invention;

FIG. 8 is an exploded perspective view of a male connector of the electronic connector assembly;

FIG. 9 is a cross sectional view of the male connector in FIG. 8; and

FIG. 10 is another cross sectional view of the electronic connector assembly in accordance with the present invention.

### DETAILED DESCRIPTION OF THE EMBODIMENTS

The present invention relates to an electronic connector assembly for improving a locking structure between a female connector and a male connector. Other objects, advantages and novel features of the invention will become more apparent from the following detailed description when taken in conjunction with the accompanying drawings.

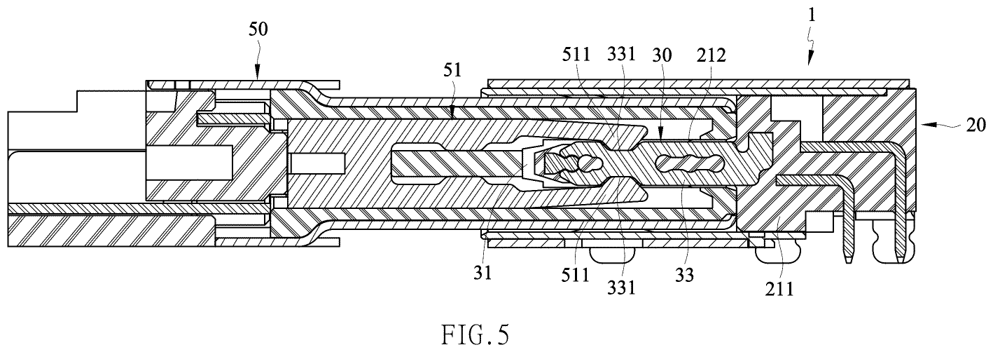

With reference to FIG. 5, the electronic connector assembly in accordance with the present invention comprises a female connector 1 and a male connector 50. The male connector 50 can be inserted into the female connector 1.

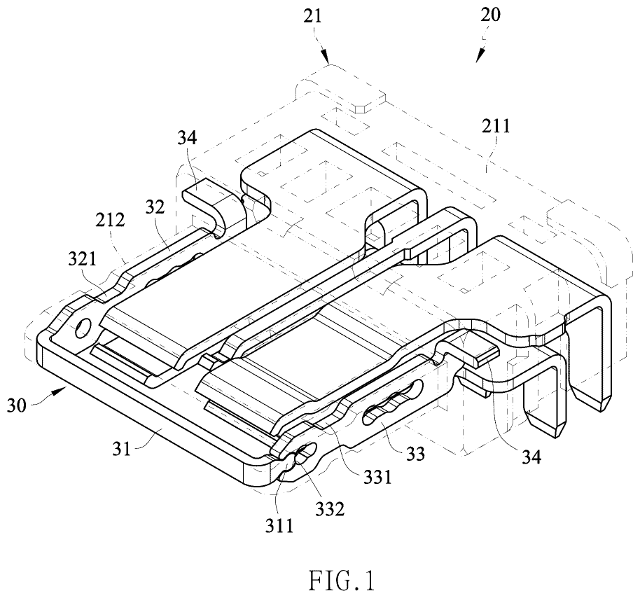

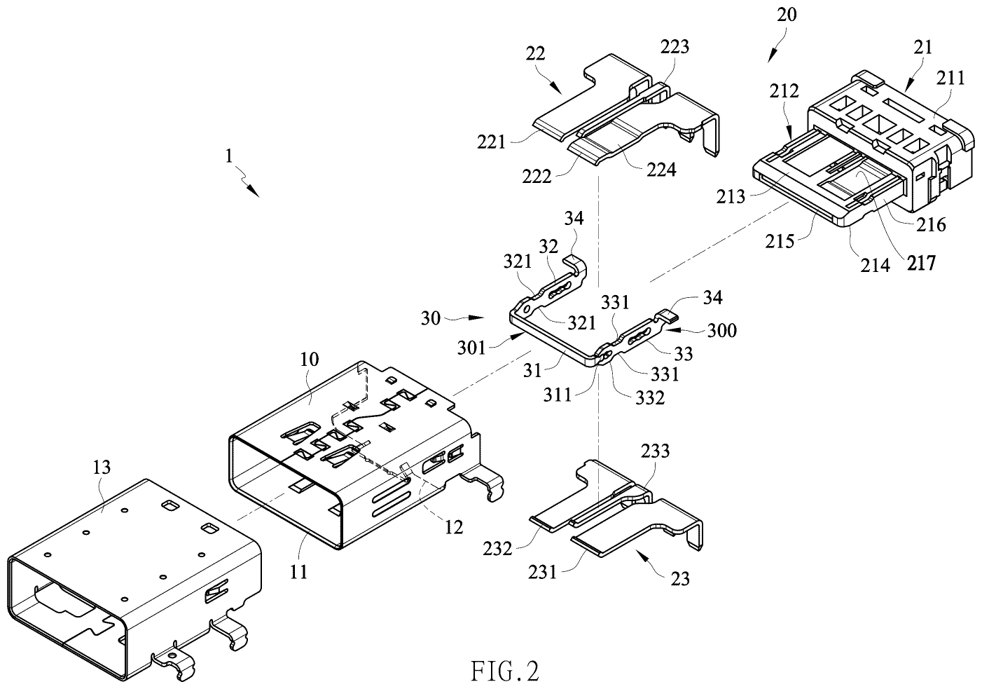

With reference to FIGS. 1 and 2, the female connector comprises a housing 10, a terminal base 20 and a hard wall 30.

The first housing 10 has a front opening 11 and a rear opening 12. In an embodiment, the first housing 10 can further comprise a second housing 13 mounted around the first housing 10.

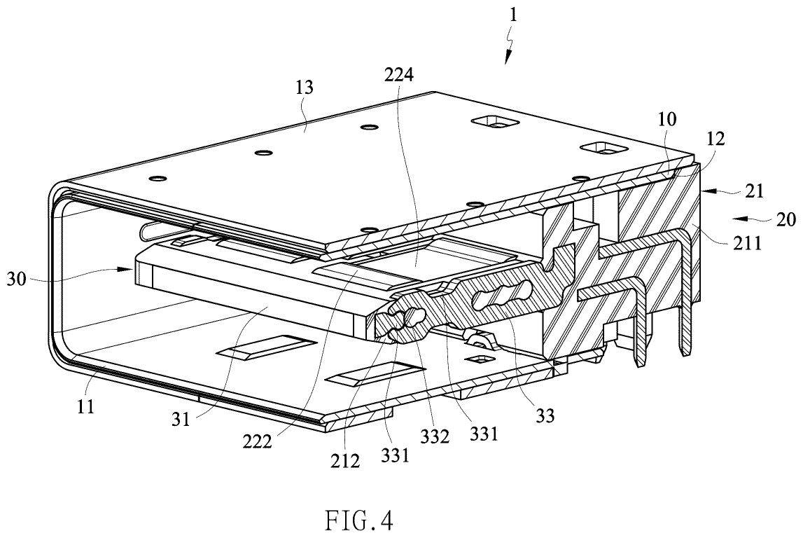

The terminal base 20 comprises an insulation base 21 and at least one terminal assembly. The insulation base comprises a base 211 and a tongue 212. With reference to FIG. 4, the base 211 is located at the rear opening 12 of the first housing 10, and the tongue 212 extends from a front end of the base 211 toward the front opening 11 of the first housing 10. The tongue 212 has a top surface 213, a bottom surface 214, two opposite sides 216, and a front side 215. The at least one terminal assembly includes multiple metal terminals mounted respectively on the top surface 213 or the bottom surface 214 of the tongue 212, and a rear end of each metal terminal extends through and exposes from the base 11. In this embodiment, the terminal base 20 has a first terminal assembly 22 and a second terminal assembly 23. The first terminal assembly 22 comprises multiple first electrode terminals and at least one first signal terminal 223. The second terminal assembly 23 comprises multiple second electrode terminals and at least one second signal terminal 233. The first electrode terminals and the first signal terminal 223 are mounted on the top surface 213 of the tongue 212, and the second electrode terminals and the second signal terminal 233 are mounted on the bottom surface 214 of the tongue 212.

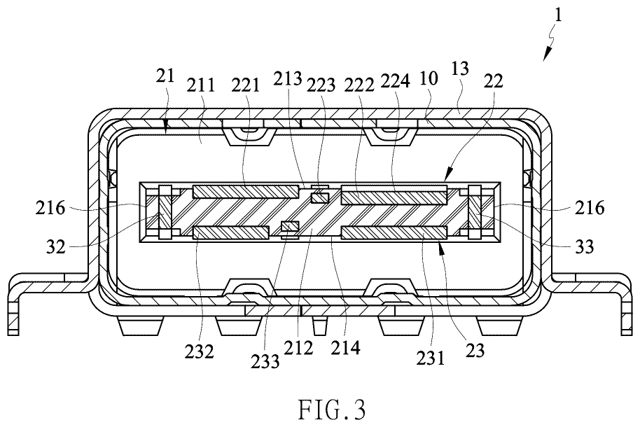

In this embodiment, the female connector 1 may be a charging connector, so the first electrode terminal includes a first positive electrode board 221 and a first negative electrode board 222. The thickness of each electrode board 221, 222 is wider than that of the first signal terminal 223 to increase charge rating current. Thus, the second electrode terminal includes a second positive electrode board 231 and a second negative electrode board 232. The thickness of each of the electrode boards 231, 232 is also wider than that of the second signal terminal 233. Accordingly, to make the male connector to be inserted into the female connector 1 in two different directions for charging, as shown in FIG. 3, the first positive electrode board 221, the first negative electrode board 222, the second positive electrode board 231, the second negative electrode board 232 are arranged in a staggered manner. This means that the first positive electrode board 221 corresponds to the lower second negative electrode board 232 in position and the first negative electrode board 222 corresponds to the lower second positive electrode board 231 in position. The first signal terminal 223 and the second signal terminal 233 may be located at a middle position of the tongue 212, or as shown in FIG. 3, are arranged in a staggered manner for fitting with positions of signal terminals in the male connector 50. In addition, the first signal terminal 223 is located between the first positive terminal 221 and the first negative terminal 222, and the second signal terminal 233 is located between the second positive terminal 231 and the second negative terminal 232. In other words, the first signal terminal 223 is located between the first positive electrode board 221 and the first negative electrode board 222, and the second signal terminal 233 is located between the second positive electrode board 231 and the second negative electrode board 232.

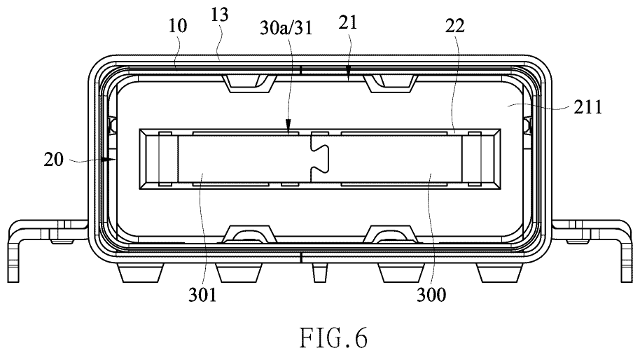

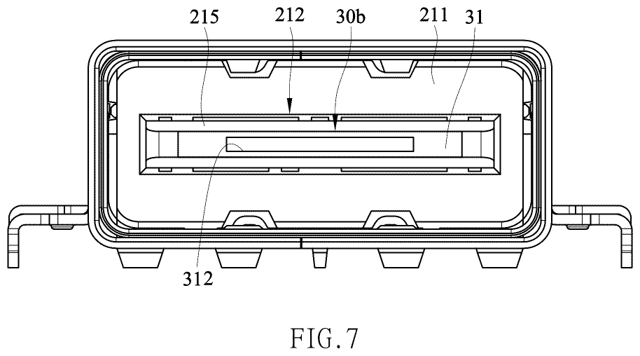

The hard wall 30 is mounted on the tongue 212 of the insulation base 21 and is harder than the tongue 212. The hard wall 30 is completely or partially embedded in the two opposite sides 216 and the front side 215 of the tongue 212. The hard wall 30 includes two sidewalls 32, 33 and a front wall 31 located between the sidewalls 32,33. In an embodiment, the hard wall 30 is bent by a metal plate to make the metal plate be easily combined with the tongue in a plastic injection process. With reference to FIGS. 1 and 2, the hard wall 30 is composed of two metal plates 300, 301. In a top view, one of the metal plates 300 is straight and the other metal plate 301 is L-shaped. The straight metal plate 300 has a recess 332 defined in an end of the metal plate 300, and the L-shaped metal plate has a protrusion 311 formed on an end of the metal plate 300 and engaged with the recess 332. Furthermore, the connection between the two metal plates 300, 301 can be connected with each other by laser welding. In addition, the engagement position or the welding connection position between the metal plates 300, 301 is located at one of the sidewalls 33 of the hard wall 30. In another embodiment, with reference to FIG. 6, the engagement position or the welding connection position between the metal plates 300, 301 is located at the front wall 31 of the hard wall 30a. In a further embodiment, with reference to FIG. 7, the front wall 31 of the hard wall 30b has an opening 312 defined through the front wall 31. Additionally, the hard wall 30 can be electrically connected with a positive potential, a negative potential, or a signal source.

The rear ends of the two sidewalls 32,33 of the hard wall 30 extend into the base 211 and each sidewall 32,33 has a wing 34 formed on the rear end of the sidewall 32,33 to firmly connect with the base 211 and the two wings 34 of the sidewalls 32,33 extend toward different directions, respectively. With reference to FIG. 1, each sidewall 32, 33 has a notch 321,331 defined in the sidewall 32,33 at a position corresponding to the top surface 213 or the bottom surface 214 of the tongue 212. In an embodiment, only one notch 231,331 is defined in a position corresponding to the top surface 213 or the bottom surface 214 of the tongue 212.

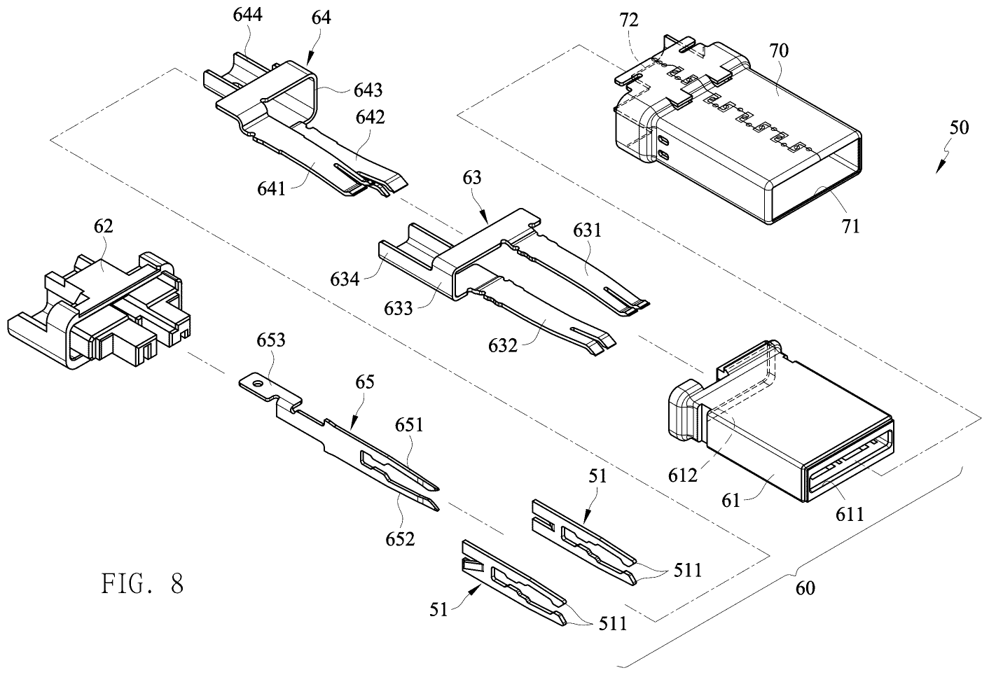

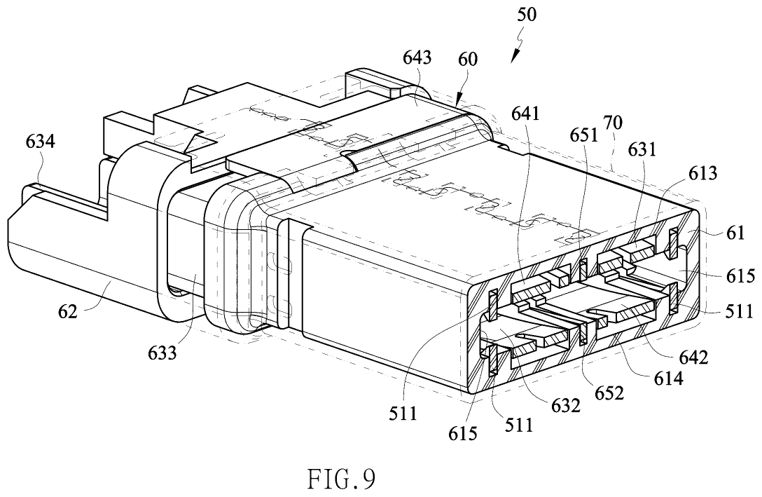

With reference to FIGS. 8 and 9, the male connector 50 comprises a casing 70, a resilient terminal 60 and two locking elements 51.

The casing is made of metal and comprises a front opening 71 and a rear opening 72.

The resilient terminal base 60 is mounted in the casing 70 and comprises an insulation socket and at least one resilient terminal assembly. The insulation socket comprises a socket body 61 and an insulation block 62. The socket body 61 has a front opening 611, a rear opening 612, an upper wall 613, a lower wall 614, and two sidewalls 615. The front opening 612 corresponds to the front opening 71 of the casing 70 in position. The insulation block 62 is located in the rear opening 612 of the socket body 61. In an embodiment, the resilient terminal assembly includes multiple resilient terminals mounted on the upper wall 613 or the lower wall 614 to correspond respectively to the metal terminals on the top surface 213 or the bottom surface 214 of the tongue 212 as shown in FIG. 5. In this embodiment, with reference to FIGS. 2, 8, and 10, the male connector 50 includes a first resilient terminal assembly and a second resilient terminal assembly. The first resilient terminal assembly comprises multiple first resilient electrode terminals and at least one first resilient signal terminal 651, and the second resilient terminal assembly comprises multiple second resilient electrode terminals and at least one second resilient signal terminal 652. The first resilient electrode terminals and the at least one first resilient signal terminal 651 are mounted on the upper wall 613 of the socket body 61 to correspond to the first electrode terminals and the first signal terminal 223 on the top surface 213 of the tongue 212 in position. The second resilient electrode terminals and at least one second resilient signal terminal 651 are mounted on the lower wall 614 of the socket body 61 to correspond to the second electrode terminals and the second signal terminal 233 on the bottom surface 214 of the tongue 212 in position.

In this embodiment, the male connector 50 is a charging connector. With reference to FIGS. 8 and 9, the first resilient electrode terminals includes a first resilient positive electrode board 631 and a first resilient negative electrode board 641. The thickness of each electrode board 631, 641 is wider than that of the first resilient signal terminal 651 to increase the charge rating current. The second resilient electrode terminals includes a second resilient positive electrode board 632 and a second resilient negative electrode board 642. The thickness of each electrode board 632, 642 is wider than that of the second resilient signal terminal 652. To fit with the female connector 50 in both directions, the first resilient positive electrode board 631, the first resilient negative electrode board 641, the second resilient positive electrode board 632, the second resilient negative electrode board 642 are arranged in a staggered manner. This manner that the first positive electrode board 631 corresponds to the lower second resilient negative electrode board 642 in position, and the first resilient negative board 641 corresponds to the lower second resilient positive electrode board 632 in position. The first resilient signal terminal 651 is located between the first resilient positive terminal 631 and the first resilient negative terminal 641, and the second resilient signal terminal 652 is located between the second resilient positive terminal 632 and the second resilient negative terminal 642. The first resilient signal terminal 651 and the second resilient signal terminal 652 may be located at a middle position of the socket body 61, or as shown in FIG. 9, are arranged in a staggered manner to fit with the positions of the first signal terminal 233 and the second signal terminal 233 on the female connector 1 as shown in FIG. 3. In this embodiment, rear ends of the first resilient signal terminal 651 and the second resilient signal terminal 652 are connected integrally with other to form a tuning fork shape, extend into the insulation block 62 and are provided with a welding tab 653. A first collar portion 633 is formed on and is integrally connected with the rear ends of the first resilient positive electrode board 631 and the second resilient positive electrode board 632 and is located in the insulation block 62. A first welding plate 643 is formed on the rear end of the first collar portion 633 to form as a positive terminal board 63. A second collar portion 643 is formed on and is integrally connected with the rear ends of the first resilient negative electrode board 641 and the second resilient negative electrode board 642. The second collar portion 643 is exposed outside the insulation block 62 and is arranged substantially concentrically with the first collar portion 633. A second welding plate 644 is formed on the rear end of the first collar portion 633 to form as a negative terminal board 63.

The two locking elements 51 are mounted in the socket body 61 and are adjacent respectively to two inner sidewalls 615 of the socket body 61. This means that the locking elements 51 are located at positions outside of the first resilient terminal assembly and the second resilient terminal assembly. With reference to FIG. 5, when the male connector 50 is inserted into the female connector 1, the locking elements 51 are engaged respectively with the notches 321,331 in the sidewalls 32,33 of the hard wall 30 in the female connector 1. In this embodiment, each locking element 51 is a formed as a tuning fork and has two engagement portions 511. Two notches 321,331 are defined in each sidewall 32,33 of the hard wall 50 respective at two positions corresponding to the top surface 213 and the bottom surface 214 of the tongue 212, and are engaged respectively with the engagement portions 511 of the locking elements 51. In an embodiment, the notches 321,331 in the sidewalls 32,33 of the hard wall 30 are exposed respectively from the top surface 213 and the bottom surface 214 of the tongue 212. The front wall 31 of the hard wall 30 is embedded inside or partially exposed from the front side 215 of the tongue 212.

With reference to FIGS. 3, 9, and 10, the first resilient positive electrode board 631, the first resilient signal terminal 651, and the first resilient negative electrode board 641 of the first resilient terminal assembly in the male connector 50 respectively contact the first positive electrode board 221, the first signal terminal 223, and the first negative electrode board 222 in the female connector 1. The second resilient positive electrode board 632 and the second resilient negative electrode board 642 of the second resilient terminal assembly in the male connector 50 respectively contact the second positive electrode board 231 and the second negative electrode board 232 in the female connector 1.

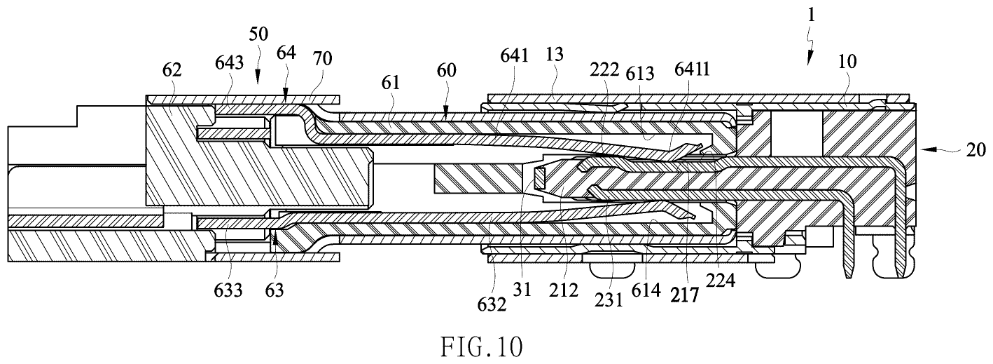

With reference to FIGS. 2 and 10, to keep the male connector 50 from being detached from the female connector 1, at least one of the electrode boards may further have a recess-protrusion segment 224 formed thereon. At least one recess-protrusion segment 217 is formed on a part of an area of the top surface 213 or the bottom surface 214 of the tongue 212 of the female connector 1. Alternatively, at least one of the electrode boards has the recess-protrusion segment 224, or all of the electrode boards have the recess-protrusion segment 224. In this embodiment, a recess-protrusion segment 217 is formed on the top surface 213 of the tongue 212 at a position corresponding to a middle portion of the first negative electrode board 222, and the first negative electrode board 222 has a recess-protrusion segment 224 formed on a position corresponding to the recess-protrusion segment 217. Accordingly, when the male connector is inserted into the female connector 1, a contact portion 6411 of the first resilient negative board 641 is located at the recess-protrusion segment 224. Preferably, the contact portion 6411 of the first resilient negative board 641 contacts a lowest position of the recess-protrusion segment 224 on the first negative board 222. Therefore, comparing to a horizontal level, the contact with the recess-protrusion segment 224 can release an external pulling force applied to the male connector 50 to prevent the male connector 50 from being detached from the female connector 1.

In summary, the female connector in accordance with the present invention has a hard wall embedded in the two opposite sides and the front side of the tongue. A notch is defined in each sidewall of the hard wall at a position corresponding to the top surface or the bottom surface of the tongue and exposed from the tongue. When the male connector is inserted into the female connector, the two locking elements in the insulation base are engaged respectively with the notches in the sidewalls of the hard wall. Accordingly, the hard wall in the female connector in accordance with the present invention can enhance the structural strength of the terminal base. A locking effect can be provided to the male connector to prevent the male connector from being detached from the female connector.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An electronic connector assembly comprising:
a female connector comprising
a first housing;
a terminal base mounted in the first housing and comprising an insulation base and at least one terminal assembly mounted on a tongue formed on the insulation base; and
a hard wall embedded in two opposite sides and a front side of the tongue, being harder than the tongue, and comprising
two sidewalls partially embedded respective in the two opposite sides of the tongue, and each sidewall having a notch defined in at least one position corresponding to a top surface or a bottom surface of the tongue and exposed from the tongue; and
a front wall embedded in the front side of the tongue and located between the two sidewalls of the hard wall; and
a male connector selectively inserted into the female connector and comprising
a casing;
a resilient terminal mount mounted in the casing and comprising an insulation socket and at least one resilient terminal assembly mounted in the insulation socket, wherein when the male connector is inserted into the female connector, the at least one resilient terminal assembly contacts the at least one metal terminal assembly of the female connector; and
a locking element mounted in the insulation socket, being adjacent to one of two inner sidewalls of the insulation socket, wherein when the male connector is inserted into the female connector, the locking element is engaged with the notch defined in a corresponding one of the sidewalls of the hard wall.

2. The electronic connector assembly as claimed in claim 1, wherein the hard wall is composed of two metal plates, and a connection of the two metal plates is located at one of the two sidewalls or the front wall of the hard wall.

3. The electronic connector assembly as claimed in claim 2, wherein one of the metal plates of the hard wall has a recess, and the other metal plate has a protrusion engaged with the recess.

4. The electronic connector assembly as claimed in claim 3, wherein the metal plate having the recess is straight and the metal plate having the protrusion is L-shaped.

5. The electronic connector assembly as claimed in claim 3, wherein the metal plate having the recess is L-shaped and the metal plate having the protrusion is straight.

6. The electronic connector assembly as claimed in claim 2, wherein the two metal plates are connected with each other by welding.

7. The electronic connector assembly as claimed in claim 1, wherein
each sidewall of the hard wall has two notches defined respectively at two positions corresponding respectively to a top surface and a bottom surface of the tongue and exposed from the tongue; and
the male connector is implemented as two locking elements, and each locking element of the male connection has two engagement portions engagement respectively the notches in a corresponding one of the sidewalls of the hard wall.

8. The electronic connector assembly as claimed in claim 7, wherein
the first housing has a front opening and a rear opening;
the insulation base comprises a base located at the rear opening of the first housing, and the tongue extends from a front end of the base toward the front opening of the first housing;
a wing extending from a rear end of each sidewall of the hard wall and extending into the base of the insulation base; and
the front wall of the hard wall is partially exposed from the front side of the tongue.

9. The electronic connector assembly as claimed in claim 7, wherein
the first housing has a front opening and a rear opening;
the insulation base comprises a base located at the rear opening of the first housing, and the tongue extends from a front end of the base toward the front opening of the first housing;
a wing extends from a rear end of each sidewall of the hard wall and extends into the base of the insulation base; and
the front wall of the hard wall has an opening.

10. The electronic connector assembly as claimed in claim 7, wherein the two engagement portions of each locking element is integrally connected with each other to form as a tuning fork shape.

11. The electronic connector assembly as claimed in claim 1, wherein
the first housing has a front opening and a rear opening;
the insulation base comprises a base located at the rear opening of the first housing, and the tongue extends from a front end of the base toward the front opening of the first housing;
each one of the at least one terminal assembly comprises multiple metal terminals mounted on the top surface or the bottom surface of the tongue;
the insulation socket comprises
a socket body comprising a front opening, a rear opening, an upper wall, a lower wall, and two sidewalls; and
an insulation block located at the rear opening of the socket body; and
each one of the at least one resilient terminal assembly comprising multiple resilient terminals mounted on the upper wall or the lower wall of the socket body and corresponding respectively to the metal terminals mounted on the top surface or the bottom surface of the tongue.

12. The electronic connector assembly as claimed in claim 11, wherein
the at least one terminal assembly includes a first terminal assembly mounted on the top surface of the tongue and a second terminal assembly mounted on the bottom surface of the tongue; and
the at least one resilient terminal assembly includes a first resilient terminal assembly mounted on the upper wall of the socket body and a second resilient terminal assembly mounted on the lower wall of the socket body.

13. The electronic connector assembly as claimed in claim 12, wherein
the first terminal assembly comprises a first positive electrode board and a first negative electrode board;
the second terminal assembly comprises a second positive electrode board corresponding to the first negative electrode board in position and a second negative board corresponding to the first positive electrode board in position;
the first resilient terminal assembly comprises a first resilient positive electrode board and a first resilient negative electrode board;
the second resilient terminal assembly comprises a second resilient positive electrode board corresponding to the first resilient negative electrode board in position and a second resilient negative board corresponding to the first resilient positive electrode board in position.

14. The electronic connector assembly as claimed in claim 13, wherein
the first terminal assembly further comprises a first signal terminal arranged between the first positive electrode board and the first negative electrode board;
the second terminal assembly further comprises a second signal terminal arranged between the second positive electrode board and the second negative electrode board;
the first resilient terminal assembly further comprises a first resilient signal terminal arranged between the first resilient positive electrode board and the second resilient negative electrode board; and
the second resilient terminal assembly further comprises a second resilient signal terminal arranged between the second resilient positive electrode board and the second resilient negative electrode board.

15. The electronic connector assembly as claimed in claim 13, wherein
one of the first positive electrode board, the first negative electrode board, the second positive electrode board, and the second negative board has a recess-protrusion portion; and
one of the first resilient positive electrode board, the first resilient negative electrode board, the resilient second positive electrode board, and the resilient second negative board has a contact portion contacting the recess-protrusion portion.

16. The electronic connector assembly as claimed in claim 15, wherein a recess-protrusion segment formed on the top surface or the bottom surface of the tongue and corresponding to the recess-protrusion portion in position.

17. The electronic connector assembly as claimed in claim 2, wherein the hard wall is electrically connected with a positive potential, a negative potential, or a signal source.

18. A female connector comprising:
a female connector comprising
a first housing;
a terminal base mounted in the first housing and comprising an insulation base and at least one terminal assembly mounted on a tongue formed on the insulation base; and
a hard wall embedded in two opposite sides and a front side of the tongue, being harder than the tongue, and comprising
two sidewalls partially embedded respective in the two opposite sides of the tongue, and each sidewall having a notch defined in at least one position corresponding to a top surface or a bottom surface of the tongue and exposed from the tongue; and
a front wall embedded in the front side of the tongue and located between the two sidewalls of the hard wall.

19. The female connector as claimed in claim 18, wherein the hard wall is composed of two metal plates, and a connection of the two metal plates is located at one of the two sidewalls or the front wall of the hard wall.

20. The female connector as claimed in claim 19, wherein one of the metal plates of the hard wall has a recess, and the other metal plate has a protrusion engaged with the recess.
